(19) United States
(12) Patent Application Publication
(10) Pub. No.: US 2025/0378326 A1
(43) Pub. Date: Dec. 11, 2025

(54) DEVICE AND METHOD FOR TRAINING A MACHINE LEARNING SYSTEM FOR NODE CLASSIFICATION OR LINK PREDICTION IN GRAPH STRUCTURED DATA

(71) Applicant: Robert Bosch GmbH, Stuttgart (DE)

(72) Inventors: Dongzhuoran Zhou, Karlsruhe (DE); Evgeny Kharlamov, Muenchen (DE)

(21) Appl. No.: 19/212,103

(22) Filed: May 19, 2025

(30) Foreign Application Priority Data
Jun. 7, 2024 (DE) 10 2024 205 293.0
Sep. 19, 2024 (DE) 10 2024 209 009.3

(51) Int. Cl. G06N 3/08; G06N 3/0464

(52) U.S. Cl. CPC G06N 3/08; G06N 3/0464

(57) ABSTRACT

A computer-implemented method for training a graph neural network to classify nodes or predict missing links in graph structured data. The method includes using node feature embeddings and a series of layers of the graph neural network to determine updated node feature embeddings, with a key step being the mapping of aggregated node feature embeddings to a compact Riemannian manifold. The training process optimizes a loss function to minimize the deviation between the graph neural networks output and the desired node classification or missing link prediction.

### CROSS REFERENCE

The present application claims the benefit under 35 U.S.C. § 119 of German Patent Application Nos. DE 10 2024 205 293.0 filed on Jun. 6, 2024, and DE 10 2024 209 009.3 filed on Sep. 19, 2024, which are both expressly incorporated herein by reference in their entireties.

### FIELD

The present invention relates to a computer implemented method for training a machine learning system for node classification or link prediction in graph structured data, a corresponding training system, a control system, a computer program, and a machine-readable storage medium.

### BACKGROUND INFORMATION

Graph neural networks (GNNs) are effective instruments for examining graph-structured data. Most GNNs utilize a message-passing technique to learn node feature embeddings, which includes gathering information from neighboring nodes and transforming/updating node feature embeddings at each layer. This approach allows GNNs to efficiently gather intricate details from graph-structured data. When GNNs are equipped with a deep stack of layers, they often face a notable decline in performance, a phenomenon primarily ascribed to the issue known as over-smoothing. Over-smoothing occurs as the depth of the GNN increases, leading to the node features across the graph becoming increasingly similar and eventually indistinguishable. This homogenization of features diminishes the model's ability to capture and leverage the distinct characteristics of each node, thereby reducing the effectiveness of the GNN in tasks such as node classification, link prediction, or graph classification. Essentially, as more layers are added, the unique information contained in the nodes' initial features-provided as an input to the GNN—is progressively lost, making it challenging for the network to perform well on its intended tasks.

In order to address the over-smoothing issue, one approach is to add skip-connections for multi-hop message passing.

In arxiv.org/abs/1910.12933, Hyperbolic Graph Neural Networks are described for addressing the over-smoothing issue.

### SUMMARY

According to a first aspect, the present invention relates to a computer-implemented method of training a machine learning system for node classification or missing link prediction in graph structured data. According to an example embodiment of the present invention, graph structured data may comprise nodes and relations between pairs of the nodes. As a non-limiting example, nodes may represent entities, such as, e.g., production cells for manufacturing of workpieces, performance and/or equipment of production cells (comprising one or several production robot(s)), different operations that can be executed for manufacturing a/different workpiece(s) by a certain production cell, and/or sensor measurements from an inspection of workpieces produced by a production cell. The machine learning system is a graph neural network with several layers. Updated node feature embeddings may be obtained as the output of a layer of the machine learning system and may be provided as an input to a subsequent layer. As initial input data, the machine learning system receives node feature embeddings of the graph structured data. These input node feature embeddings may be an initial representation of the graph structured data nodes' features within an Euclidean space, preferably a high-dimensional Euclidian space, preferably allowing for an initial capture of the nodes' attributes and their relationships within the graph structured data. In this context, an input node feature embedding may have been obtained by mapping one or several words describing/defining an entity of the graph structured data in, e.g., a language into an Euclidean vector space, preferably a high-dimensional Euclidean vector space. The mapping may be provided by a (trained) bag of words/BERT (Bidirectional Encoder Representations from Transformers) or other language model, which may receive one or several words describing an entity of the graph structured data as an input and which may provide as output a corresponding representation of said entity as a vector in an Euclidean vector space. In a non-limiting example, the dimension of the high-dimensional Euclidean vector space may be given by, e.g. 256. In other words, the process of obtaining the input node feature embeddings may involve various techniques, including but not limited to, one-hot encoding of categorical attributes or dimensional reduction techniques, bag of word models, BERT (Bidirectional Encoder Representations from Transformers) models. In initial capturing of the nodes' attributes and their relationships within the graph structured data by the input node feature embeddings may be achieved by an ability of the mapping to encode intrinsic characteristics of entities in graph structured data and the nature of their relationships into the geometric positioning and orientation of the corresponding vectors in the Euclidean space. Entities that may share similar attributes or may be closely related within the graph structured data may, e.g., tend to be positioned closer together in the Euclidean vector space, while those that are dissimilar or loosely connected may, e.g., be placed further apart.

According to an example embodiment of the present invention, a layer of the machine learning system determines from node feature embeddings-provided as an input to said layer-updated node feature embeddings as an output of said layer, by applying to the input of said layer an aggregation in Euclidean space and subsequently a transformation. In other words, said layer determines an update of the feature embeddings provided as an input to said layer. The output of said layer, i.e. the updated feature embeddings, may comprise neighbouring-node influenced node embeddings, respectively. Accordingly, the updated feature embeddings may comprise enriched knowledge on relations and/or properties of further neighboring nodes. By the aggregation, respective aggregated node feature embeddings are determined from the input node feature embeddings of said layer. The respective aggregated node feature embeddings are then mapped/projected to a compact Riemannian manifold before subsequently applying the transformation.

In other words, in a layer of the machine learning system, a two-step process to update node feature embeddings is performed. In a first step an aggregation within Euclidean space is performed, where the node feature embeddings of a node and its neighbors are combined to form a cohesive representation, i.e., an aggregated node feature embedding of that node, that reflects the local topology of the graph structured data around that node. This aggregation may comprise summing, averaging, and/or choosing the maximum out of the node feature embeddings of neighboring nodes. By the aforementioned operations, or a combination of them, different aspects of the local graph structure may be encapsulated into a node's aggregated node feature embedding. In a second step the aggregated node feature embeddings are mapped or projected onto a compact Riemannian manifold. The subsequent transformation is then applied to the mapped/projected aggregated node feature embeddings. By determining the transformation of the mapped/projected aggregated node feature embeddings, the updated node feature embeddings are obtained. Preferably, the updated node feature embeddings are elements of the compact Riemannian manifold. In other words, preferably, the transformation may be a mapping from the compact Riemannian manifold onto the compact Riemannian manifold. The transformation may further refine the aggregated node feature embeddings, e.g., prepares them for a subsequent layer or for a final output of the machine learning system. For instance, the transformation may involve non-linear operations. For instance, the transformation may adjust the mapped/projected aggregated node feature embeddings in a way congruent with the manifold's structure. According to an example embodiment of the present invention, the method of training the machine learning system may comprise the following steps:
In a first step, training data comprising initial node feature embeddings from graph structured data may be received together with corresponding node classification or missing link prediction task output data,
In a second step, the machine learning system may be trained by optimizing a loss function, wherein the loss function determines a deviation between the output data determined by the machine learning system and the corresponding node classification or missing link prediction task output data.

Advantageously, according to an example embodiment of the present invention, the steps of aggregation, subsequent projection to the compact Riemannian manifold and a final transformation-again mapping onto the compact Riemannian manifold-allow to mitigate the problem of over-smoothing and hence allow to better maintain the distinctiveness of node embeddings referring to entities and relations in the graph structured data. Particularly, it has been observed that a performance drop in node classification tasks may be mitigated when using a graph neural network in such task with the above-described features and trained according to the above-described steps, with respect to a graph neural network trained for the same task but without the projection to a compact Riemannian manifold. In particular, the performance with respect to e.g. a node classification task may even be increased the higher the number of layers in the graph neural network. Accordingly, with the proposed method and/or architecture of the machine learning system, deeper graph neural networks may be constructed and tasks requiring fine grained differentiation/distinction between nodes may be tackled.

It is worth to stress that the method according to the present invention provided herein is neither limited to a specific type of a graph neural network nor to a specific application.

Preferably, according to an example embodiment of the present invention, the compact Riemannian manifold is determined by n-dimensional vectors x∈Rⁿ with x·U·x^{T}=1, wherein U∈R^{n×n} is a positive-definite matrix, x·U·x^{T}>0, ∀x∈Rⁿ≠0.

An example of a compact Riemannian manifold with the above definition is the (n−1)-dimensional hypersphere, S⁽ⁿ⁻¹⁾, embedded in the n-dimensional Euclidean space Rⁿ. The vectors x∈Rⁿ with x·Uₛ·x^{T}=1 define points on the surface of the hypersphere, and the positive-definite n×n unity matrix Uₛ=diag(1, . . . ,1) ensures positive orientation of the manifold. Other examples may be given by an (n−1)-dimensional ellipsoid, embedded in n-dimensional Euclidean space Rⁿ.

For instance, if a simplified graph convolution model (SGC) is considered as an example of a GNN, the exemplary application of the herein described method to the SGC may be described as follows. Input node feature embeddings to a layer, e.g. the kth layer, of the SGC may be denoted by H^{(k-1)}. In this notation, the rows of matrix H^{(k-1)} may be the input node feature embeddings to the kth layer, respectively. Then the updated node feature embeddings H^{(k)} determined as an output of the kth layer (again, in this notation, the output node features may be given in the rows of matrix H^{(k)})—obtained as output of the kth layer of the SGC—may, in the example, be obtained by

$${P}_{U} ( {\tilde{D}}^{- \frac{1}{2}} \cdot \tilde{A} \cdot {\tilde{D}}^{- \frac{1}{2}} \cdot {H}^{( k - 1 )} ) ,$$

wherein P_{U}(x)=(x/\sqrt{x·U·x^{T}}). Augmented matrices Ã=A+I and \tilde{D}=D+I, with I the m×m identify matrix, are defined by D=diag(d₁, d₂, . . . , dₘ) with

$${d}_{i} = {\sum }_{j = 1}^{m} {A}_{i , j} ,$$

wherein m denotes the number of nodes in graph G, wherein parameters dᵢ shall be adjusted during training. It shall be understood in the notation introduced with P_{U} that P_{U} is applied to each row of the matrix

$${\tilde{D}}^{- \frac{1}{2}} \cdot \tilde{A} \cdot {\tilde{D}}^{- \frac{1}{2}} \cdot {H}^{( k - 1 )}$$

separately, respectively. By applying P_{U}, a projection to the compact Riemannian manifold determined as above is provided. It may be noted that in case of the SGC, the aggregation is given by

$${\tilde{D}}^{- \frac{1}{2}} \cdot \tilde{A} \cdot {\tilde{D}}^{- \frac{1}{2}} ,$$

such that the aggregated node feature embeddings are given by the rows of

$${\tilde{D}}^{- \frac{1}{2}} \cdot \tilde{A} \cdot {\tilde{D}}^{- \frac{1}{2}} \cdot {H}^{( k - 1 )} .$$

These are mapped onto the compact Riemannian manifold by applying P_{U} to each row of the resulting matrix. The transformation in case of SGC is then simply the identity operation on the result

$${P}_{U} ( {\tilde{D}}^{- \frac{1}{2}} \cdot \tilde{A} \cdot {\tilde{D}}^{- \frac{1}{2}} \cdot {H}^{( k - 1 )} ) ,$$

such that in the example of SGC, the updated node feature embeddings are elements of the compact Riemannian manifold.

According to an example embodiment of the present invention, preferably, the Riemannian manifold is a torus, a double torus, an ellipsoid or a hypersphere in Rⁿ.

Advantageously, according to an example embodiment of the present invention, the machine learning system for node classification or missing link prediction in graph structured data showed improved performance on node classification or missing link prediction tasks when mapping/projecting respective aggregated node feature embeddings in respective layers of the machine learning system to a torus, a double torus, an ellipsoid or a hypersphere in Rⁿ before applying the transformation due to avoidance of over-smoothing, i.e. avoiding that node feature embeddings become increasingly similar and eventually indistinguishable as they would—without the step of projecting to a Riemannian manifold—converge to a single point. Furthermore, the performance on node classification or missing link prediction of the machine learning system with an ellipsoid in Rⁿ as Riemannian manifold was surprisingly improved with respect to the cases with a torus, double torus, or hypersphere.

Preferably, the parameters of the positive definite matrix U are adjusted during the training of the machine learning system.

Adjusting the parameters of the positive definite matrix U during training of a machine learning system allows for the adaptation of the manifold representation to better alleviate over-smoothing and hence improves the overall performance of the machine learning according to its specific task such as, e.g. missing link prediction or node classification in specific domains wherein domain specific graph structured data are considered. This adjustment can lead to improved model performance and generalization, as the manifold representation becomes more tailored to the specific characteristics of the graph structured data in specific domains. Experiments surprisingly showed that adjusting the parameters of the positive definite matrix U during training of a corresponding machine learning system—instead of predetermining the corresponding parameters—may lead to a matrix U characterizing an ellipsoid as Riemannian manifold.

In other words, adjusting the parameters of the positive definite matrix U may enable the machine learning system to learn a more suitable and optimized representation of the data manifold, leading to enhanced discriminative power, better separation of classes, and improved overall performance in tasks such as node classification or missing link prediction.

Preferably, according to an example embodiment of the present invention, the transformation in said layer of the machine learning system further comprises the following steps:
Mapping the respective aggregated node feature embeddings of said layer after their projection to the compact Riemannian manifold to a hyperplane in Rⁿ by a push forward projection function,
Applying a non-linear transformation to the result, e.g. by successively applying a weight matrix and an activation function,
Subsequently mapping the result of the linear transformation to the Riemannian manifold by a push back projection function.

The steps of mapping by a push forward projection function and a push back projection function, respectively, are projection steps, i.e., the push forward projection function may be a projection function, e.g., a generalization of a stereographic projection and the push back projection function may be a generalization of the corresponding inverse of the respective projection function, e.g., of the stereographic projection, respectively.

The example embodiment described in the previous two paragraphs may, e.g., be applied to an adaption of a herein described method to a graph convolutional network (GCN) or to a Graph Attention Network (GAT). In this paragraph, this adaption to a GCN or a GAT may be explained in more detail. In a layer of the GCN or GAT, after the respective aggregated node feature embeddings are mapped/projected to the compact Riemannian manifold, a transformation shall be applied to these aggregated node feature embeddings. To implement the method to GCNs/GATS, the transformation shall be a transformation from the compact Riemannian manifold onto the compact Riemannian manifold. In this paragraph, the compact Riemannian manifold may be denoted by [symbol] _{U}⊂Rⁿ. Furthermore, N_{b}={x=(x₁, . . . , xₙ)∈Rⁿ, x₁=b} with b>0, may denote a hyperplane in Rⁿ. The transformation may then take three steps. In a first step, aggregated node feature embeddings may be mapped from the Riemannian manifold [symbol] _{U} to the hyperplane N_{b} using a push forward projection function, PF. In a next step, a mapping from N_{b} to Rⁿ may be performed by a standard transformation function, e.g. x→σ(x·W). Here σ denotes an activation function, e.g., ReLU, sigmoid, Tanh or softmax, and W∈R^{n×n} is a weight matrix with parameters to be adjusted during training of the GCN/GAT model. In a last step, a mapping from Rⁿ to the compact Riemannian manifold [symbol] _{U} may be performed by a push back projection function, PB. For instance, the push forward projection function PF may be defined by

$$PF = ( w ) = ( \frac{b - {a}_{0}}{{w}_{1} - {a}_{0}} ) \cdot ( w - {x}_{0} ) + {x}_{0} ,$$

with w=(w₁, . . . , wₙ)∈ [symbol] _{U} and x₀=(α₀, 0, . . . ,0), wherein

$${a}_{0} = {U}_{11}^{- \frac{1}{2}} , and {U}_{11}^{- \frac{1}{2}}$$

denotes the square-root of the element U₁₁ in the first row and column of matrix U. The push back projection function PB may, for instance, be defined by

$$PB ( v ) = ( \frac{- 2 ( v - {x}_{0} ) {Ux}_{0}^{T}}{- 2 ( v - {x}_{0} ) {Ux}_{0}^{T}} ) \cdot ( v - {x}_{0} ) + {x}_{0}$$

with vector v∈Rⁿ.

To summarize, in the example of applying the method to a GCN/GAT, a layer of a GCN/GAT may update node feature embeddings H^{(k-1)} obtained as an input to updated node feature embeddings H^{(k)}. Generally, in the notation introduced herein, H^{(k-1)} may denote a matrix with a layer's—here, e.g., the kth layer's—input node feature embeddings in its rows and H^{(k)} may denote a matrix with the respective layer's updated node feature embeddings in its rows. In case of the above two examples of application to GCNs or GATs, it may be noted, that in the exemplary case of GCNs, aggregation may be expressed by application of

$${\tilde{D}}^{- \frac{1}{2}} \cdot \tilde{A} \cdot {\tilde{D}}^{- \frac{1}{2}}$$

to H^{(k-1)}, where H^{(k-1)} denotes a matrix with the layer's input node feature embeddings in its rows. Specifically, in the case of GCNs, updated node feature embeddings H^{(k)} may be determined from node feature embeddings H^{(k-1)} obtained as an input to the layer by

$${\overline{H}}^{( k )} = {P}_{U} ( {\tilde{D}}^{- \frac{1}{2}} \cdot \tilde{A} \cdot {\tilde{D}}^{- \frac{1}{2}} \cdot {H}^{( k - 1 )} ) , {H}^{( k )} = PB ( σ ( PF ( {\overline{H}}^{( k )} ) \cdot {W}^{( k )} ) ) .$$

In the example of GATs, aggregation is determined with an attention function, Att, such that in this case updated node feature embeddings H^{(k)} may be determined from node feature embeddings H^{(k-1)} obtained as an input to the layer by

$${\overline{H}}^{( k )} = {P}_{U} ( Att ( {H}^{( k - 1 )} ) \cdot {H}^{( k - 1 )} ) , {H}^{( k )} = PB ( σ ( PF ( {\overline{H}}^{( k )} ) \cdot {W}^{( k )} ) ) .$$

The attention function Att may be defined as in www.arxiv.org/pdf/1710.10903.

As introduced above, projection to the Riemannian manifold is obtained by the mapping P_{U}(x)=(x/\sqrt{x·U·x^{T}}). Augmented matrices Ã=A+I and \tilde{D}=D+I, with I the m×m identify matrix, are defined by D=diag(d₁, d₂, . . . , dₘ) with

$${d}_{i} = {\sum }_{j = 1}^{m} {A}_{i , j} ,$$

wherein m denotes the number of nodes in graph G, wherein parameters dᵢ shall be adjusted during training. It shall be understood in the notation introduced with P_{U} that P_{U} is applied to each row of the matrix

$${\tilde{D}}^{- \frac{1}{2}} \cdot \tilde{A} \cdot {\tilde{D}}^{- \frac{1}{2}} \cdot {H}^{( k - 1 )}$$

or the matrix Att(H^{(k-1)})·H^{(k-1)} separately, respectively.

Preferably, according to an example embodiment of the present invention, the graph structured data describe a topology of production cells, wherein the nodes in the graph structured data represent different production cells for manufacturing a workpiece or different workpieces, and/or the nodes in the graph structured data represent a performance and/or equipment of production cells, and/or wherein the nodes in the graph structured data represent different operations that can be executed for manufacturing a workpiece of different workpieces by a certain production cell, and/or the nodes in the graph structured data represent sensor measurements from an inspection of workpieces produced by a production cell.

In other words, the graph structured data describe the layout of production cells, with nodes representing production cells, workpieces, performance/equipment, manufacturing operations, and/or sensor measurements.

Advantageously, this may allow for a comprehensive representation of the manufacturing process, enabling efficient monitoring, optimization, and analysis of production operations. Processing the structured graph data by the method described herein may facilitate the analysis of the relationships and interactions between production cells, workpieces, operations, and equipment, leading to improved process control, resource allocation, and quality assurance in manufacturing.

Preferably, according to an example embodiment of the present invention, the last layer of the machine learning system determines from the updated node feature embeddings provided as an input to the last layer a classification of at least one node in the graph structured data as an output, the method further comprising the following steps. In a first step, inference data comprising node feature embeddings from graph structured data as input data of the machine learning system are received. In a subsequent step, a classification of the input data is determined as an output of the machine learning system, wherein the classification is indicative of a status of a production cell and/or a quality of a produced workpiece and/or a sensor measurement from an inspection of workpieces produced by a production cell. In a following step, a control signal for at least one actuator in a production cell is determined from the classification if the status of the production cell and/or the quality of the produced workpiece and/or the sensor measurements is/are outside predefined boundaries. In a following method step, the actuator is controlled with the determined control signal. Preferably, the at least one actuator may be an actuator controlling a robot in a production cell. In further embodiments, preferably, the at least one actuator may be an actuator controlling a motor, position/orientation of a sensor, a valve, and/or a switch in the production cell.

In other words, in such embodiment the final layer of the machine learning system may receive the updated node feature embeddings of a second to last layer of the graph neural network as an input and determine from those a classification of at least one node in the graph structured data. According to this embodiment, the method may comprise the step of receiving inference-time data, determining a classification indicative of production cell status, workpiece quality, or sensor measurements, and generating a control signal for actuators in the production cells based on the determined classification.

Advantageously, this may enable (real-time) decision-making and control in manufacturing processes, leading to improved efficiency, quality control, and proactive maintenance.

Preferably, according to an example embodiment of the present invention, a machine tool in a production cell is controlled depending on the output of the machine learning system, in particular in case of a classification indicating an error, the machine tool is stopped or a corresponding error message is outputted.

According to a further aspect, the present invention relates to a training system comprising a processor configured to perform a method of training of the present invention as described herein.

According to a further aspect, the present invention relates to a control system, which is configured to determine a control signal by carrying out method steps of the present invention described above, wherein the control signal is configured to control an actuator.

According to a further aspect, the present invention relates to a computer program with machine-readable instructions, which, when executed on one or several computer(s), cause the computer(s) to perform one of the computer-implemented methods described above and below. Furthermore, according to another aspect, the present invention relates to a machine-readable storage medium, on which the above computer program is stored.

An Euclidean space may be a finite-dimensional vector space over the real numbers R with a norm. A norm may be given by the square-root of an inner product of an element of the vector space with itself. The inner product of two elements of the finite-dimensional vector space over the real numbers may in this case be given by the square-root of the sum of the squares of the differences of the elements' coordinates. E.g., Rⁿ is a n-dimensional Euclidean space, with norm

$$\vert x \vert = \sqrt{{x}_{1}^{2} + ⋯ + {x}_{n}^{2}}$$

for x∈Rⁿ, x=(x₁, . . . , xₙ). Other norms are also possible.

For completeness, it may be added that, generally, a d-dimensional manifold [symbol] shall be a hyper-surface in the Euclidean space Rⁿ with n≥d such that each point on the manifold has an (open) neighborhood that is homeomorphic to an open subset of Rⁿ (i.e., locally looks like Rⁿ). A Riemannian manifold [symbol] shall be a manifold along with a Riemannian metric, from which one can derive a distance function d_{M}(x, y) for points x, y∈ [symbol] thus making [symbol] a metric space. Accordingly, one may have closed and compact Riemannian manifolds. A compact manifold is a Riemannian manifold that is also being a compact metric space.

Generally, it may be understood, that graph-structured data may be represented by a (undirected) graph G=(V,E), wherein graph G may be defined by a pair of a nodes set V and a edges set E. Let D=diag(d₁, d₂, . . . , dₘ) with

$${d}_{i} = {\sum }_{j = 1}^{m} {A}_{i , j} ,$$

wherein m denotes the number of nodes in graph G. May further augmented matrices be defined as Ã=A+I and \tilde{D}=D+I, with I the m×m identify matrix. May now a graph G be given, as well as initial node feature embeddings of graph G, represented by/arranged in H⁽⁰⁾, wherein the rows of the m×n matrix H⁽⁰⁾ are given by the respective n-dimensional initial node feature embeddings of the nodes of G. Here, the word ‘initial’ refers to the fact that the respective node feature embeddings shall be provided as an input to a graph neural network. Generally speaking, a graph neural network A with several layers may update the node feature embeddings in a following way, H^{(k)}=Tran∧{(k)}(Agg(H^{(k-1)})), wherein H^{(k)} may denote/may refer to the updated node feature embeddings of the kth layer, i.e. the output of the kth layer of GNN A, and H^{(k-1)} to the node feature embeddings received as input by the kth layer of GNNA. Tran and Agg may refer to transformation and aggregation. Generally, for a simple GNN, Tran and Agg may be defined by

$$Agg ( H ) = {\tilde{D}}^{- \frac{1}{2}} \cdot \tilde{A} \cdot {\tilde{D}}^{- \frac{1}{2}} \cdot H ,$$

Tran(H)=σ(H·W). Here σ may denote an activation function, e.g., ReLU, sigmoid, Tanh or softmax, that may be applied to each row of its matrix argument, respectively, and W∈R^{n×n} may define a weight matrix. It may generally be said that GNN A is over manifold [symbol] in Rⁿ if its aggregation and transformation are over [symbol] .

Example embodiments of the present invention will be discussed with reference to the figures in more detail.

### BRIEF DESCRIPTION OF THE DRAWINGS

FIG. 1 shows a flow chart of an exemplary embodiment of the present invention.

FIG. 2 shows a flow chart of an exemplary embodiment of the present invention.

FIG. 3 shows a training system for training the machine learning system for node classification or missing link prediction, according to an example embodiment of the present invention.

### DETAILED DESCRIPTION OF EXAMPLE EMBODIMENTS

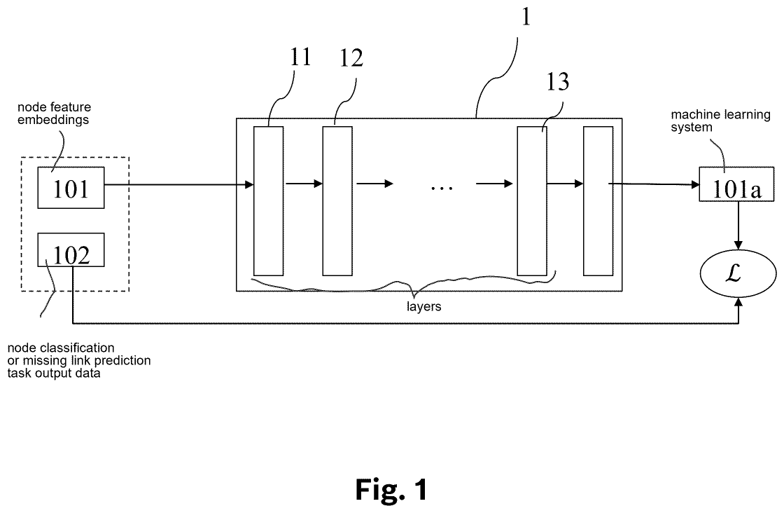

FIG. 1 shows a flowchart of an exemplary embodiment of the present invention. Machine learning system 1 is a graph neural network with several layers 11, 12, 13, wherein the machine learning system 1 receives node feature embeddings 101 from the graph structured data as input data. A layer (11, 12, 13) of the machine learning system 1 determines from node feature embeddings provided as an input to said layer updated node feature embeddings as an output of said layer by subsequently applying to the input of said layer an aggregation in Euclidean space and a transformation, wherein the aggregation determines from the input node feature embeddings of said layer respective aggregated node feature embeddings. The respective aggregated node feature embeddings are mapped/projected to a compact Riemannian manifold before applying the transformation.

Training data comprising node feature embeddings 101 from graph structured data and corresponding node classification or missing link prediction task output data 102 are received. Machine learning system 1 is trained by optimizing a loss function [symbol] , wherein the loss function [symbol] determines a deviation between the output data determined by the machine learning system 101a and the corresponding node classification or missing link prediction task output data 102.

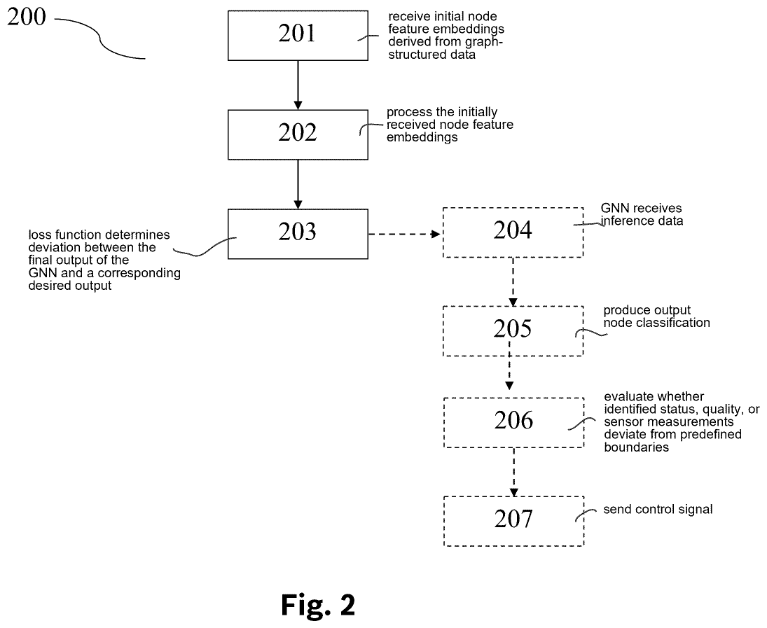

FIG. 2 shows a flowchart of a computer implemented method 200 according to another exemplary embodiment. In step 201, a machine learning system, a GNN, according to embodiments described herein, receives initial node feature embeddings derived from graph-structured data. Graph structured data may refer to a topology of production cells, wherein the nodes in the graph structured data may represent different production cells for manufacturing a workpiece or different workpieces, and/or the nodes in the graph structured data may represent a performance and/or equipment of production cells, and/or wherein the nodes in the graph structured data may represent different operations that can be executed for manufacturing a workpiece or different workpieces by a certain production cell, and/or the nodes in the graph structured data may represent sensor measurements from an inspection of workpieces produced by a production cell. The initial node feature embeddings serve as the initial input data for the GNN. In step 202, layers of the GNN process the initially received node feature embeddings. This involves two main operations in each of the layers used for updating node feature embeddings within the GNN: a. The respective layer aggregates the node feature embeddings received as an input of that layer to produce aggregated node feature embeddings. b. Before further processing, the aggregated node feature embeddings are then projected onto a compact Riemannian manifold. c. Following the projection, a transformation is applied to the embeddings now situated within the Riemannian manifold, resulting in updated node feature embeddings as the output of the layer. In step 203, a loss function determines a deviation between the final output of the GNN and a corresponding desired output (e.g. the desired output for a node classification task or a missing link prediction) and parameters of the GNN are adjusted in order to optimize the loss function. A final output of the GNN may be received as at least one node classification, wherein the node classification may be determined from the GNN's last determined updated node feature embeddings. After training of the GNN, in optional inference step 204, the GNN may receive inference data, which include node feature embeddings extracted from graph-structured data. This data may serve as the input for the machine learning system at inference time and may refer to a topology of production cells, wherein the nodes in the graph structured data may represent different production cells for manufacturing a workpiece or different workpieces, and/or the nodes in the graph structured data may represent a performance and/or equipment of production cells, and/or wherein the nodes in the graph structured data may represent different operations that can be executed for manufacturing a workpiece or different workpieces by a certain production cell, and/or the nodes in the graph structured data may represent sensor measurements from an inspection of workpieces produced by a production cell. In optional method step 205, the machine learning system processes the input data to produce an output node classification. This classification may provide insights into various aspects of the production process, such as the status of the production cell, the quality of the workpieces produced, or sensor measurements obtained during the inspection of these workpieces. In further optional method step 206, based on the output classification of step 205, it may be evaluated whether the identified status, quality, or sensor measurements deviate from predefined boundaries. If a deviation is detected, a control signal for controlling one or more actuators within the production cell may be determined. In further optional method step 207, the determined control signal may be sent to relevant actuator(s) in the production cell. This action aims to adjust or correct the identified deviation, thereby optimizing the production process. Particularly, in this step of in an additional step, a machine tool may be controlled, in particular in case of a classification indicating an error, the machine tool may be stopped or a corresponding error message may be outputted.

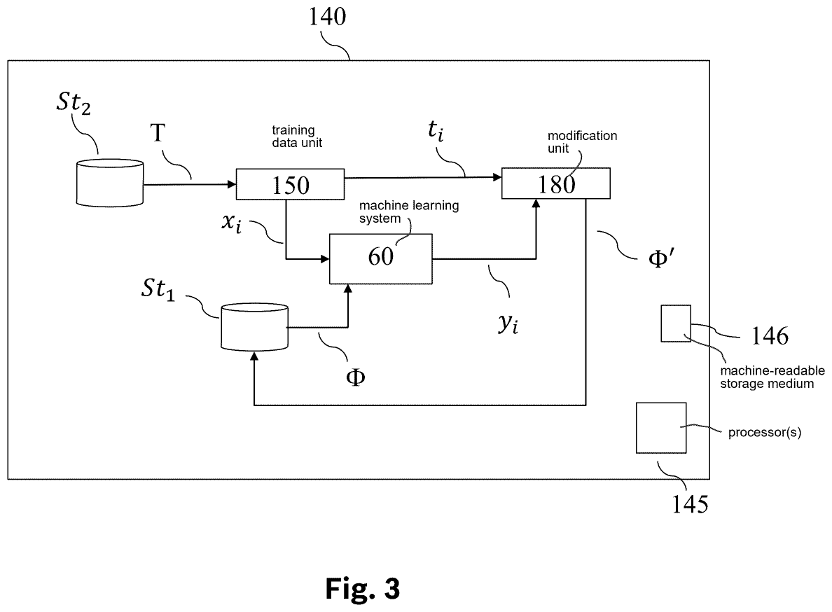

FIG. 3 shows an embodiment of a training system 140 for training the machine learning system 60 by means of a training data set T. The training data set T comprises a plurality of input signals xᵢ, each input signal representing initial node feature embeddings referring to particular graph-structured data, which are used for training the machine learning system 60, wherein the training data set T further comprises, for each input signal xᵢ a desired output signal to which corresponds to the input signal xᵢ. The desired output signal may be given by/characterize a classification of at least one node feature embedding of the node feature embeddings comprised in the input signal xᵢ.

For training, a training data unit 150 accesses a computer-implemented database St2, the database St2 providing the training data set T. The training data unit 150 determines from the training data set T preferably randomly at least one input signal xᵢ and the desired output signal tᵢ corresponding to the input signal xᵢ and transmits the input signal xᵢ to the machine learning system 60. The machine learning system 60 determines an output signal yᵢ based on the input signal xᵢ.

The desired output signal tᵢ and the determined output signal yᵢ are transmitted to a modification unit 180.

Based on the desired output signal tᵢ and the determined output signal yᵢ, the modification unit 180 then determines new parameters Φ′ for the machine learning system (60). For this purpose, the modification unit (180) compares the desired output signal (tᵢ) and the determined output signal (yᵢ) using a loss function. The loss function determines a first loss value that characterizes how far the determined output signal (yᵢ) deviates from the desired output signal (tᵢ).

The modification unit (180) determines the new parameters (Φ′) based on the first loss value.

In other preferred embodiments, the described training is repeated iteratively for a predefined number of iteration steps or repeated iteratively until the first loss value falls below a predefined threshold value. Alternatively or additionally, it is also possible that the training is terminated when an average first loss value with respect to a test or validation data set falls below a predefined threshold value. In at least one of the iterations the new parameters (Φ′) determined in a previous iteration are used as parameters (Φ) of the machine learning system (60).

Furthermore, the training system (140) may comprise at least one processor (145) and at least one machine-readable storage medium (146) containing instructions which, when executed by the processor (145), cause the training system (140) to execute a training method according to one of the aspects of the present invention.

The term “computer” may be understood as covering any devices for the processing of pre-defined calculation rules. These calculation rules can be in the form of software, hardware or a mixture of software and hardware.

In general, a plurality can be understood to be indexed, that is, each element of the plurality is assigned a unique index, preferably by assigning consecutive integers to the elements contained in the plurality. Preferably, if a plurality comprises N elements, wherein N is the number of elements in the plurality, the elements are assigned the integers from 1 to N. It may also be understood that elements of the plurality can be accessed by their index.

What is claimed is:

1. A computer-implemented method of training a machine learning system for node classification or missing link prediction in graph structured data, wherein the machine learning system is a graph neural network with several layers, wherein the machine learning system receives node feature embeddings from the graph structured data as input data, wherein each layer of the machine learning system determines from node feature embeddings provided as an input to the layer updated node feature embeddings as an output of the layer by subsequently applying to the input of the layer an aggregation in Euclidean space and a transformation, wherein the aggregation determines from the input node feature embeddings of the layer respective aggregated node feature embeddings, wherein the respective aggregated node feature embeddings are mapped and/or projected to a compact Riemannian manifold before applying the transformation, the method comprising the following steps:
receiving training data including node feature embeddings from graph structured data and corresponding node classification or missing link prediction task output data; and
training the machine learning system by optimizing a loss function, wherein the loss function determines a deviation between the output data determined by the machine learning system and the corresponding node classification or missing link prediction task output data.

2. The method according to claim 1, wherein the compact Riemannian manifold is determined by n-dimensional vectors x∈Rⁿ with x·U·x^{T}=1, wherein U∈R^{n×n} is a positive-definite matrix, x·U·x^{T}>0,∀x∈Rⁿ≠0.

3. The method according to claim 1, wherein the Riemannian manifold is a torus or a double torus or an ellipsoid or a hypersphere in Rⁿ.

4. The method according to claim 3, wherein parameters of the positive definite matrix U are adjusted during the training of the machine learning system.

5. The method according to claim 1, wherein the transformation in the layer further includes the following steps:
mapping the respective aggregated node feature embeddings of the layer after their projection to the compact Riemannian manifold to a hyperplane in Rⁿ by a push forward projection function;
applying a non-linear transformation to a result of the mapping;
subsequently mapping a result of a standard transformation to the Riemannian manifold by a push back projection function.

6. The method according to claim 1, wherein the graph structured data describe a topology of production cells, wherein:
the nodes in the graph structured data represent different production cells for manufacturing a workpiece or different workpieces, and/or
the nodes in the graph structured data represent a performance and/or equipment of production cells, and/or wherein the nodes in the graph structured data represent different operations that can be executed for manufacturing a workpiece or different workpieces by a certain production cell, and/or
the nodes in the graph structured data represent sensor measurements from an inspection of workpieces produced by a production cell.

7. The method according to claim 6, wherein a last layer of the machine learning system determines from the updated node feature embeddings provided as an input to the last layer a classification of at least one node in the graph structured data as an output, the method further comprising the following steps:
receiving inference data including node feature embeddings from graph structured data as input data of the machine learning system;
determining as an output of the machine learning system a classification of the input data, wherein the classification is indicative of a status of a production cell and/or a quality of a produced workpiece and/or a sensor measurement from an inspection of workpieces produced by a production cell;
determining from the classification a control signal for at least one actuator in a production cell, when the status of the production cell and/or the quality of the produced workpiece and/or the sensor measurements is outside predefined boundaries; and
controlling the actuator with the determined control signal.

8. The method according to claim 6, wherein depending on the output of the machine learning system, a machine tool is controlled, including, n case of a classification indicating an error, the machine tool is stopped or a corresponding error message is outputted.

9. A training system, comprising:
a processor configured to train a machine learning system for node classification or missing link prediction in graph structured data, wherein the machine learning system is a graph neural network with several layers, wherein the machine learning system receives node feature embeddings from the graph structured data as input data, wherein each layer of the machine learning system determines from node feature embeddings provided as an input to the layer updated node feature embeddings as an output of the layer by subsequently applying to the input of the layer an aggregation in Euclidean space and a transformation, wherein the aggregation determines from the input node feature embeddings of the layer respective aggregated node feature embeddings, wherein the respective aggregated node feature embeddings are mapped and/or projected to a compact Riemannian manifold before applying the transformation, the training comprising the following steps:
receiving training data including node feature embeddings from graph structured data and corresponding node classification or missing link prediction task output data; and
training the machine learning system by optimizing a loss function, wherein the loss function determines a deviation between the output data determined by the machine learning system and the corresponding node classification or missing link prediction task output data.

10. A control system, which is configured to:
receive inference data including node feature embeddings from graph structured data as input data of a trained machine learning system;
determine as an output of the trained machine learning system a classification of the input data, wherein the classification is indicative of a status of a production cell and/or a quality of a produced workpiece and/or a sensor measurement from an inspection of workpieces produced by a production cell; and
determine from the classification a control signal for at least one actuator in a production cell, when the status of the production cell and/or the quality of the produced workpiece and/or the sensor measurements is outside predefined boundaries, wherein the control signal is configured to control an actuator;
wherein the machine learning system is trained for node classification or missing link prediction in graph structured data, wherein the machine learning system is a graph neural network with several layers, wherein the machine learning system receives node feature embeddings from the graph structured data as input data, wherein each layer of the machine learning system determines from node feature embeddings provided as an input to the layer updated node feature embeddings as an output of the layer by subsequently applying to the input of the layer an aggregation in Euclidean space and a transformation, wherein the aggregation determines from the input node feature embeddings of the layer respective aggregated node feature embeddings, wherein the respective aggregated node feature embeddings are mapped and/or projected to a compact Riemannian manifold before applying the transformation, and wherein the training includes the following steps:
receiving training data including node feature embeddings from graph structured data and corresponding node classification or missing link prediction task output data; and
training the machine learning system by optimizing a loss function, wherein the loss function determines a deviation between the output data determined by the machine learning system and the corresponding node classification or missing link prediction task output data.

11. A non-transitory computer-readable data carrier on which is stored a computer program for training a machine learning system for node classification or missing link prediction in graph structured data, wherein the machine learning system is a graph neural network with several layers, wherein the machine learning system receives node feature embeddings from the graph structured data as input data, wherein each layer of the machine learning system determines from node feature embeddings provided as an input to the layer updated node feature embeddings as an output of the layer by subsequently applying to the input of the layer an aggregation in Euclidean space and a transformation, wherein the aggregation determines from the input node feature embeddings of the layer respective aggregated node feature embeddings, wherein the respective aggregated node feature embeddings are mapped and/or projected to a compact Riemannian manifold before applying the transformation, the computer program, when executed by a computer, causing the computer to perform the following steps:
receiving training data including node feature embeddings from graph structured data and corresponding node classification or missing link prediction task output data; and
training the machine learning system by optimizing a loss function, wherein the loss function determines a deviation between the output data determined by the machine learning system and the corresponding node classification or missing link prediction task output data.
